(19) United States
(12) Patent Application Publication
(10) Pub. No.: US 2015/0169134 A1
(43) Pub. Date: Jun. 18, 2015

(54) METHODS CIRCUITS APPARATUSES SYSTEMS AND ASSOCIATED COMPUTER EXECUTABLE CODE FOR PROVIDING PROJECTION BASED HUMAN MACHINE INTERFACES

(71) Applicant: Extreme Reality Ltd., Herzliya Pituah (IL)

(72) Inventor: Dor Givon, Tel Aviv (IL)

(21) Appl. No.: 14/401,527

(22) PCT Filed: May 20, 2013
(86) PCT No.: PCT/IB13/54146

§ 371 Date: Nov. 16, 2014

Related U.S. Application Data
(60) Provisional application No. 61/649,325, filed on May 20, 2012.

(51) Int. Cl. G06F 3/042

(52) U.S. Cl. CPC G06F 3/0425; G06F 3/0426

(57) ABSTRACT

A computerized method and apparatus for providing input to a computing platform from a user. The apparatus comprises a computing platform, a projection device for projecting an image to be displayed to a user, and a capturing device for capturing a reflection of the image or part thereof and hand or hands of a user in the vicinity of the projected image. The location of the user's hands is associated with a symbol or control command associated with the area of the projected image, and the symbol or control command are input to the computing platform or to an application associated with the projected image. A registration stage may be used for crating the association. A skeleton model may be used for determining the location of the user's hands.

### TECHNICAL FIELD

The present disclosure relates to man machine interface in general, and to methods and apparatus for providing input to a computing platform, in particular.

### BACKGROUND

Computerized devices and computer programs control almost every aspect of our life, from reading and writing documents, surfing the internet, to performing all types of activities. Many of these devices and programs require input from a user. Input may be required, for example for pointing at or otherwise indicating areas such as buttons or other controls displayed on a display device, pressing or otherwise indicating characters or other symbols which may be input using a keyboard, or the like.

Using known technologies, input can be provided using external input devices such as a keyboard, a mouse, a joystick or the like, or an add-on to the display device or to the computing platform such as a touch screen, a voice activation module, or the like.

There are, however, situations in which none of the existing technologies provides an adequate and convenient solution for inputting data into a computing platform. For example, there may not be enough space for a conventional keyboard, or the keyboard of a mobile computer or a keyboard displayed on a display device associated with a touch screen may be inconvenient for certain people.

There is thus a need for a novel method and apparatus for a user to input data into a computing platform.

### BRIEF SUMMARY

The present invention includes methods, circuits, systems and associated software for image based human machine interfacing. According to some embodiments, there are provided a projection device, an image acquisition or capturing device and image processing logic or circuits adapted to facilitate said human machine interfacing.

According to some embodiments, the projection device may include one or more controllable light emitters which may project, towards a surface, one or more symbols (e.g. characters, numbers, geometric shapes, area indicators, etc.) associated with data to be displayed to a user and to information to be input into a computing device or platform, or to a specific application executed thereon. The symbols and areas may be arranged in either a predefined, user defined or system defined arrangement or matrix (e.g. keyboard). According to further embodiments, the pattern, arrangement, or matrix may be adaptive, such that relative positions and sizes of symbols may change based on a prediction of a next symbol to be selected by the user.

According to some embodiments, there may be provided a registration stage prior to operation. Registration may include: (1) projecting the pattern, arrangement or matrix onto a projection surface which may be flat or uneven, continuous or piece-wise, or the like; (2) capturing a reflection or an image of the projection off the projection surface; (3) identifying one or more symbols in the reflection, and/or one or more parts in the reflection associated with particular functionality, such as reflection of one or more buttons, areas or characters; (4) associating a character or a command or a control to be activated with each symbol or part; (5) determining a 2D area of the projection surface and/or a 3D region including the projection surface, collectively referred to as the area or region of the projection surface, to be associated with each identified symbol or area; and (6) associating substantially each part of the area or region of the projection surface with a symbol or control command to be input to the computing platform.

As part of the registration process, specific lines of site from a fixed image acquisition device and point may be logically associated with specific commands and/or symbols. Likewise, specific pixel groups may be logically associated with specific commands and/or symbols. Accordingly, these lines of site and/or pixel groups may be set as triggers for generating their respective commands and/or symbols during operating mode/stages, for example when a user's limb, finger or the like are visually detected in a given line of site or pixel group.

According to further embodiments, there may be provided an operating stage during which a one or more images are acquired of a body part such as a finger or a hand of a user in the vicinity of a projection. The image or images are processed using image analysis techniques. Optionally, as part of the image processing, background features may be removed from the image or images of the projection on the registration phase, and from the image or images of the body part on the operational stage.

The analysis of the image or images may provide the location, or a characteristic of a location such as a projection, of the body part. The hand position may be determined using any technique, and optionally a skeleton model of the hand, which enables the extraction of particular features of the hand such as bends or proportion between segment lengths. The skeleton model may be a general model, or a specific model associated with a particular user.

The position of the hand is then associated with an area or region of the projection surface, and the symbol or functionality associated with the area or region is input to the computing platform.

In some embodiments, the location of the body part can be predicted based on the motion of the body part, which can enable performing any activity, such as enlarging the projection of the symbol or area it is guessed that the user is about to touch, or the like.

In some embodiments, if a skeleton model of the body part is used, it may be enhanced using the analysis of one or more images.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIGS. 1A, 1B and 1C show schematic illustrations of a computing device and a projection device projecting an image onto a projection surface or surfaces, and a capturing device capturing a reflection of the projection surface or surfaces and hands nearby, in accordance with some exemplary embodiments of the disclosure;

FIGS. 2A, 2B and 2C show different combinations of computing platform, projector assembly and imaging assembly, in accordance with some exemplary embodiments of the disclosure;

FIG. 3A is a flowchart of a method for registration, in accordance with some exemplary embodiments of the disclosure;

FIG. 3B is a flowchart of a method for providing input in accordance with a body part location, in accordance with some exemplary embodiments of the disclosure;

FIG. 4 is a functional block diagram of an image-based human machine interface, in accordance with some exemplary embodiments of the disclosure;

FIG. 5A is a flowchart of a method for associating a symbol or image part with an area of projection surface, in accordance with some exemplary embodiments of the disclosure;

FIG. 5B is a flowchart of a method for retrieving a symbol or control associated with a body part location, in accordance with some exemplary embodiments of the disclosure; and

FIG. 6 is a functional block diagram of a system for registration and position identification module, in accordance with some exemplary embodiments of the disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

In accordance with some embodiments of the disclosed subject matter, there is thus provided an apparatus and method for image based human machine interfacing. (HMI) According to some embodiments, there are provided a projector, an acquisition device and image processing logic adapted to facilitate said human machine interfacing.

According to some embodiments, the projector may include one or more controllable light emitters which may project, towards a surface, one or more symbols (e.g. characters, numbers, geometric shapes, area indicators, etc.) associated with data to be displayed to a user and to information to be input into a computing device or platform, or to a specific application executed thereon. The symbols and areas may be arranged in either a predefined, user defined or system defined arrangement or matrix (e.g. keyboard). According to further embodiments, the pattern, arrangement, or matrix may be adaptive, such that relative positions and sizes of symbols may change based on a prediction of a next symbol to be selected by the user.

According to some embodiments, there may be provided a registration stage prior to operation. Registration may include: (1) projecting the pattern, arrangement or matrix onto a projection surface which may be flat or uneven, continuous or piece-wise, or the like; (2) capturing a reflection of the projection off the projection surface; (3) identifying one or more symbols in the reflection, and/or one or more parts in the reflection associated with particular functionality, such as reflection of one or more buttons, areas or characters; (4) associating a character or a command or a control to be activated with each symbol or part; (5) determining a 2D area of the projection surface and/or a 3D region including the projection surface, collectively referred to as the area or region of the projection surface, with each identified symbol or area; and (6) associating substantially each part of the area or region of the projection surface with a symbol or control command to be input to the computing platform.

According to further embodiments, there may be provided an operating stage during which one or more images are acquired of a body part such as a finger or a hand of a user in the vicinity of the projection. The image or images are processed using image analysis techniques. Optionally, as part of the image processing, background features may be removed from the image or images of the projection on the registration phase, and from the image or images of the body part on the operational stage.

The analysis of the image or images provides the location, or a characteristic of a location such as a projection, of the body part. The hand position may be determined using any technique, and optionally a skeleton model of the hand, which enables the extraction of particular features of the hand such as bends or proportions between segment lengths. The skeleton model may be a general model, or a specific model associated with a particular user.

The position of the hand is then associated with an area or region of the projection surface, and the symbol or functionality associated with the area or region is input to the computing platform.

In some embodiments, the location of the body part can be predicted ahead of time based on the motion of the body part, which can enable performing any activity, such as enlarging the projection of the symbol or area it is guessed that the user is about to touch, or the like.

In some embodiments, if a skeleton model of the body part is used, it may be enhanced using the analysis of one or more images.

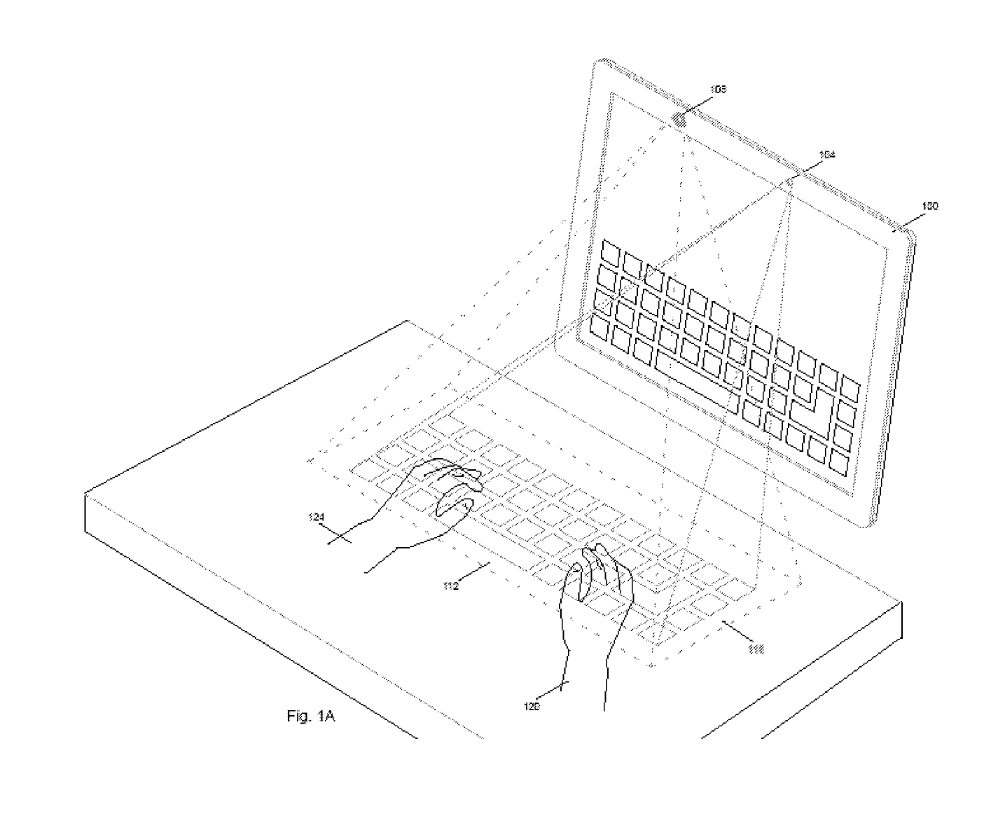

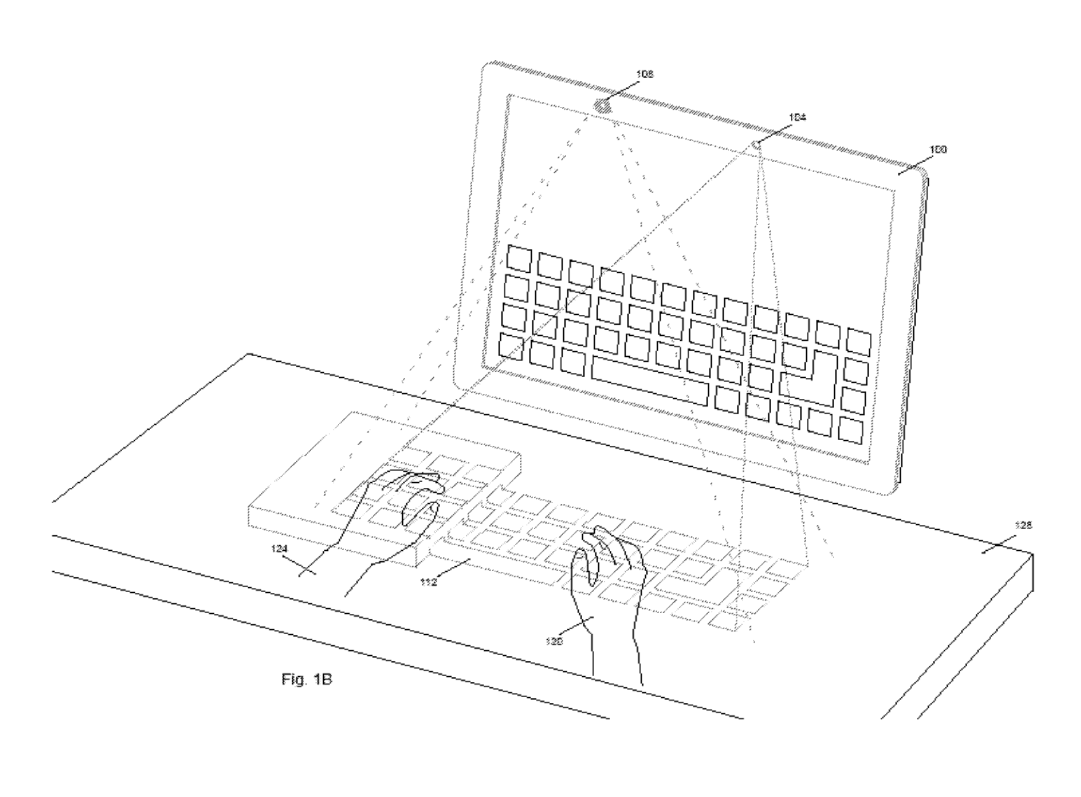

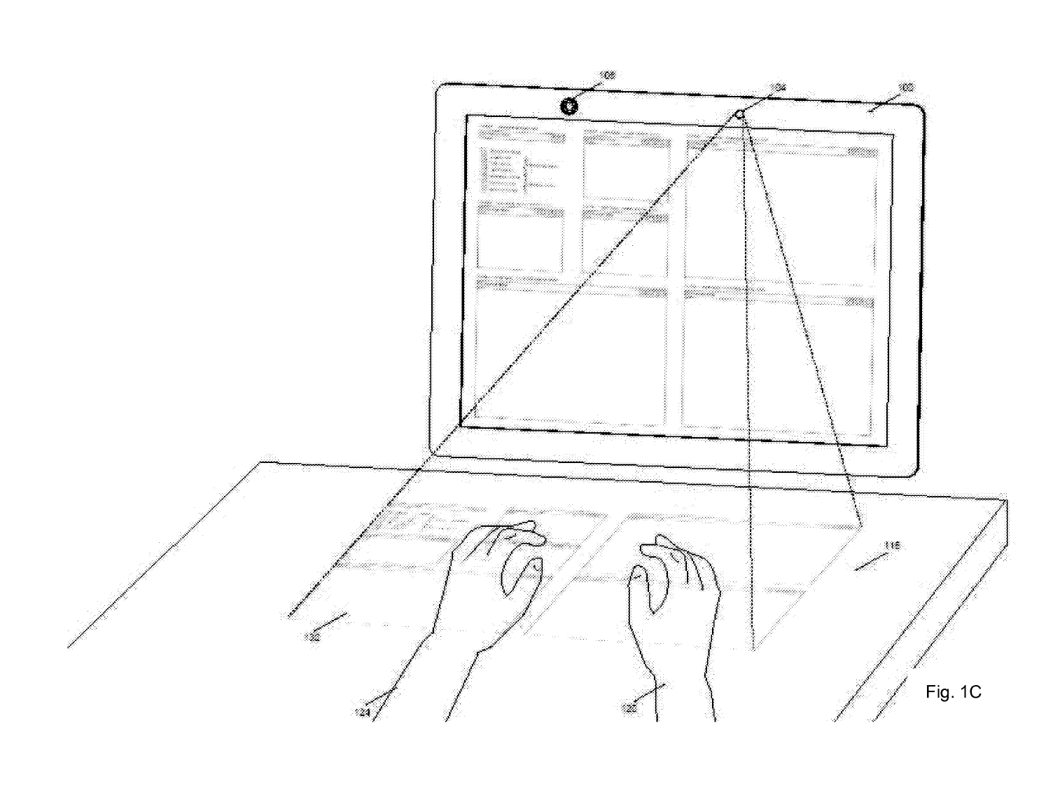

Referring now to FIG. 1A to FIG. 1C, showing typical scenarios of a person using embodiments of the system.

FIG. 1A shows a display device 100 associated with a computing device, the display device having embedded within a projection device 104 and a capturing or acquiring device 108. Projection device 104 projects the image displayed on the screen of the display device, the image containing a virtual keyboard, such that a projected image 112 is created on surface 116. A user is using the projected image by holding his or her hands 120 and 124 and in particular fingers near surface 116, and bringing one or more fingers at a time closer to areas of projected image 112 wherein characters or other symbols being a part of the keyboard are projected. Capturing device 108 is capturing a reflection of the user's hands, the captured reflection or image is analyzed by the computing device, and the symbols, characters or control commands associated with areas of in projected image 112 to which the user's fingers were closest at times, are input into an active application executed by the computing platform.

FIG. 1B also shows display device 100, projection device 104 and capturing device 108. However, surface 128 on which the image is projected, is not planar but rather piecewise, such that part of image 112 is projected on one part of the surface while another part of image 112 is projected on another part of the surface, wherein the two parts are not on the same plan. However, a reflection of user's hands 120 and 124 is captured by capture device 108 as on FIG. 1A and the image analysis provides input to an application in the same manner, regardless of the part of image 112 to which the hands are closest.

FIG. 1C shows display device 100 having embedded therein projection device 104 and capturing device 108. Projection device 104 projects the screen image, which now shows another application rather than a virtual keyboard, the application comprising sensitive areas to be touched or pointed at. A projected image 132 is created on surface 116. A user is using projected image 132 by holding his or her hands 120 and 124 and in particular fingers near surface 116, and bringing his fingers closer to various areas of projected image 132, at which the desired parts of image 132 are projected. Capturing device 108 is capturing a reflection of the user's hands, the captured image is analyzed by the computing device, and the symbols or areas in projected image 132 to which the user's fingers were closest at times are input into an active application executed by the computing platform.

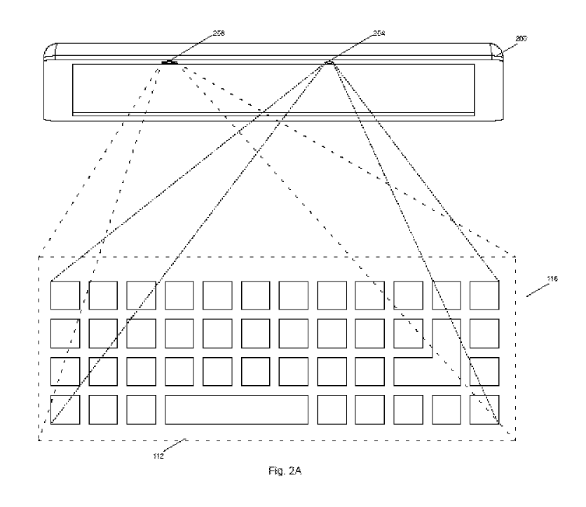

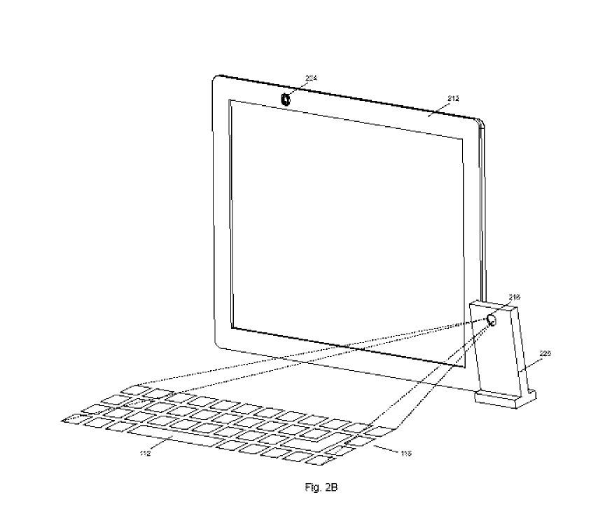

Referring now to FIG. 2A to FIG. 2C, showing projector and acquisition assemblies in preferred embodiments of human machine interface for providing input to a computing platform.

FIG. 2A shows a computing platform 200, with no associated display screen. Rather, computing platform 200 comprises a projection device 204 which projects contents to be displayed to a user onto a projection surface 116, thus generating projected image 112. Projected image 112 displayed on projection surface 116 contains, for example a virtual keyboard. Computing platform 200 is also associated with a capturing device 208, such as a web camera, a video camera, a stills camera, or the like, which can capture frequent reflections of projected image 112 and/or user's hands near projected image 112.

FIG. 2B shows another configuration in which the computing platform (not shown) is associated with a display device 212, and a separate projection device 216 is provided, which may be embedded within a base 220, a holding arm, or the like. Projection device 216 may communicate with the computing platform or with another computing platform such as a processor embedded within display device 212 using any communication protocol, such as USB, serial communication, 12C or the like. Capturing device 224 is embedded within display device 212 and captures a reflection of image 112 projected by external projection device 216.

FIG. 2C shows yet another configuration in which a base 228 or holder arm separate from the computing platform or display device has embedded therein a projection device 216 and a capturing device 224. Either base 228 or both projection device 216 and capture device 224 are in communication with a computing platform. The computing platform provides control commands to activate projection device 216 and capture device 224 in order to project the required image, capture a reflection of projected image 112 at a registration stage and capture reflection of the user's hands at the operational stage, and to receive the information as conveyed by the user moving his hands near projected image 112.

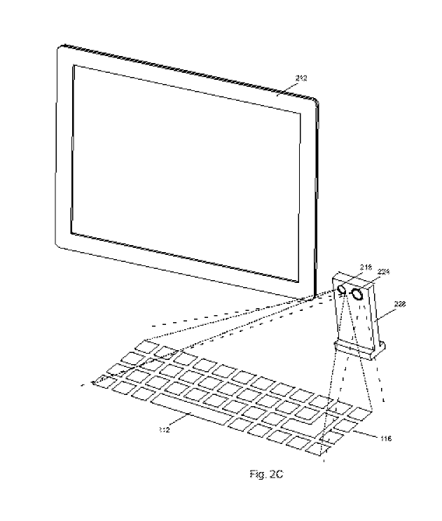

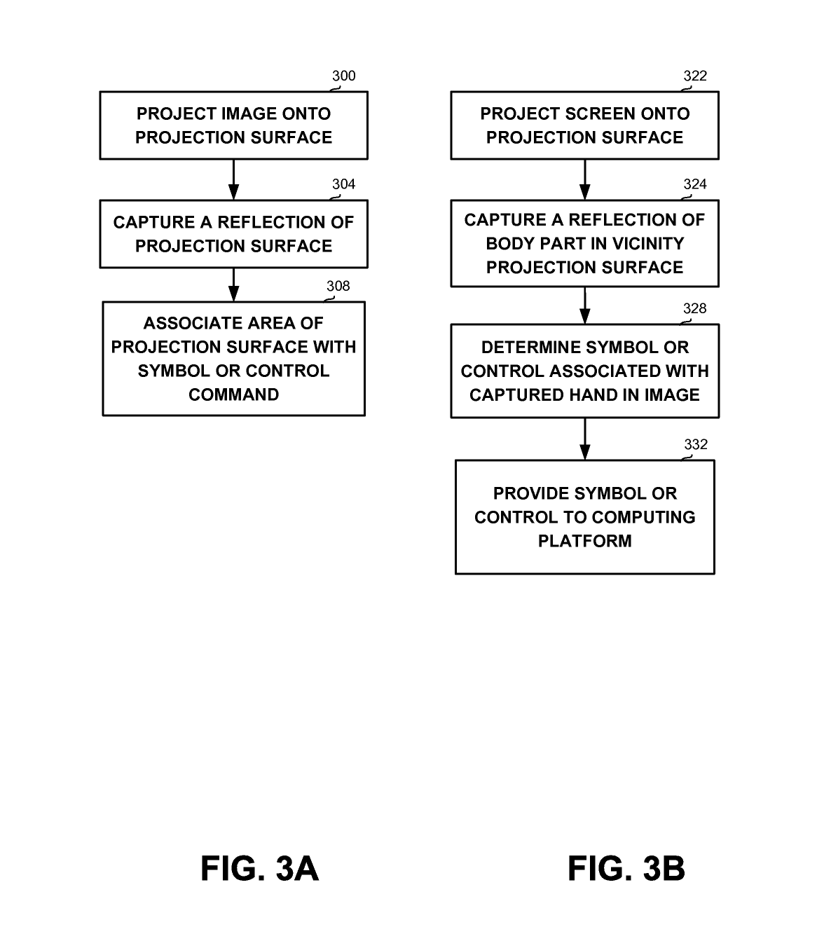

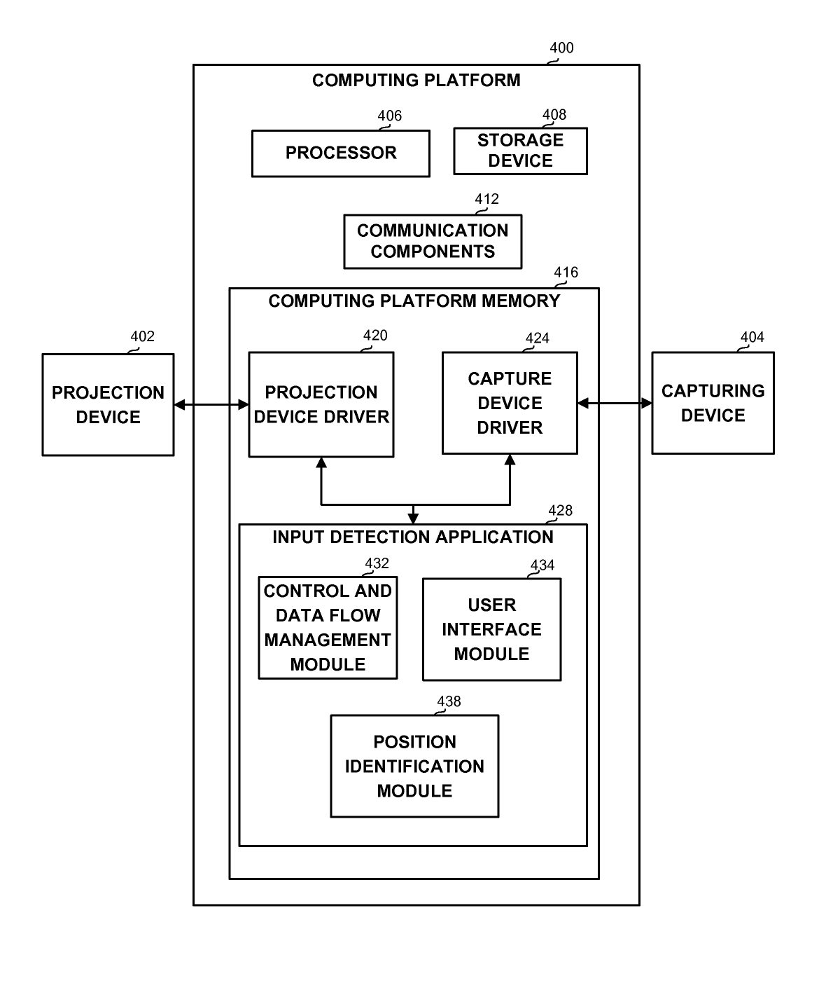

Referring now to FIG. 3A, showing a flowchart of steps in a method for registering or calibrating a projected image with symbols or associated input, and to FIG. 3B showing a flowchart of steps in a method for providing input to a computing platform using a projected image, by an HMI system. Also referring to FIG. 4, showing an exemplary embodiment of an HMI system.

In the registration or calibration method shown in FIG. 3A, an image to be displayed is generated by a computing platform and projected upon a surface, and an association is registered between locations on or near the projection surface and symbols such as characters or controls to be input into the computing platform or active application executed thereon.

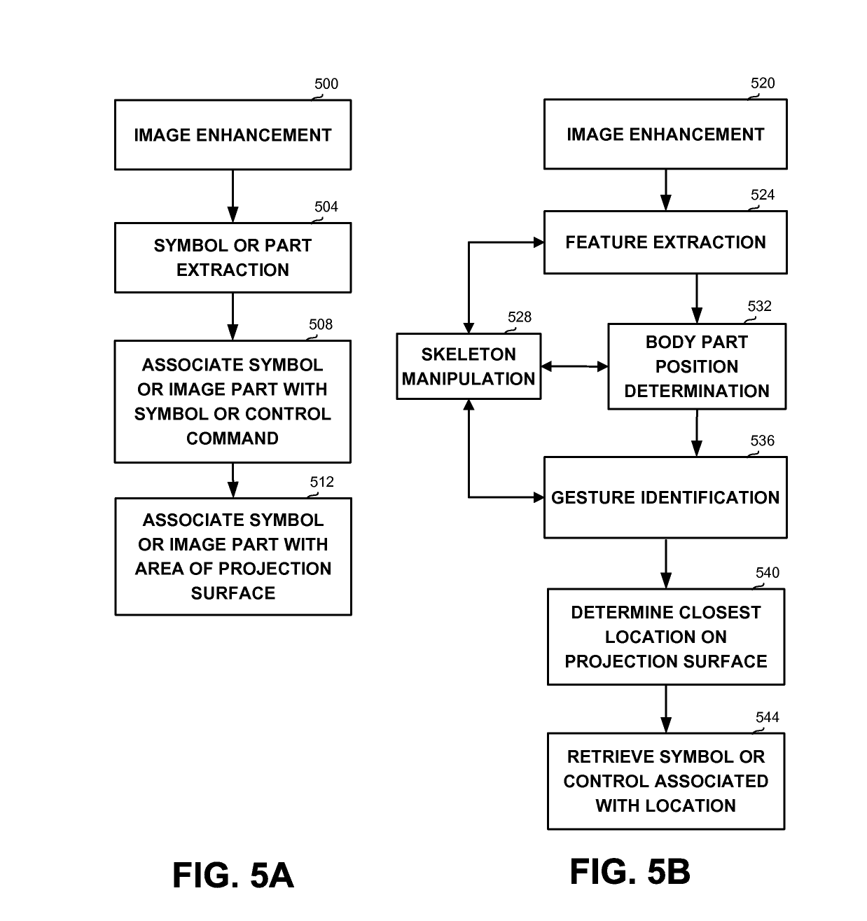

The HMI system of FIG. 4 comprises a computing platform 400. In some exemplary embodiments, computing platform 400 may comprise a processor 406. Processor 406 may be a Central Processing Unit (CPU), a microprocessor, an electronic circuit, an Integrated Circuit (IC) or the like. Alternatively, computing platform 400 can be implemented as firmware written for or ported to a specific processor such as digital signal processor (DSP) or microcontrollers, or can be implemented as hardware or configurable hardware such as field programmable gate array (FPGA) or application specific integrated circuit (ASIC). Computing platform 400 may be utilized to perform computations such as detailed in association with FIGS. 3A, 3B, 5A and 5B below or any of their steps.

In some exemplary embodiments, computing platform 400 may comprise or may be associated with one or more storage devices such as storage device 408 for storing instructions associated with the HMI, or any other computer program and/or data. The storage device may be volatile, non-transitory or persistent, and may include any computer readable storage medium, such as, but not limited to, any type of disk including one or more floppy disks, optical disks, CD-ROMs, DVDs, laser disks, or magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

Computing platform 400 further comprises a memory device 416 to which programs, libraries or modules executed by computing platform 400 are loaded. Thus, memory device 416 may be loaded with one or more executed applications, including for example an operating system of computing platform 400. Memory device 416 is also loaded with components of the HMI system as detailed below. Unless indicated otherwise the components of the HMI system are assumed to be loaded to the memory device. However, it will be appreciated by a person skilled in the art that in some embodiments not all components must be loaded to memory at all times.

On step 300 an image, comprising contents that may be displayed on a display device associated with the computing platform 400 is projected by a projection device 402 onto a projection surface. The projection surface can be planar or continuous but can also be piecewise or take any other shape or structure. Communication between computing platform 400 and projection device 402 may be performed by projection device driver 420.

On step 304 a reflection of the projection surface is captured or acquired by capturing device 404, controlled by capture device driver 424.

On step 308, using the reflection or image acquired on step 304, each character or control known to be displayed and projected is associated with a 2D area or a 3D region on or which includes part of the projection surface. Step 308 thus provides association between location on or in the vicinity of the projected image and symbols or control commands that can be indicated by a user. Step 308 is further detailed in association with FIG. 5A below.

In alternative embodiments, a coordinate system is defined which is relative to the image projected on the projection surface, so that each point in the vicinity of the projected image can be associated with coordinates or coordinate range which are relative to the projected image or a part thereon. Thus, an of the projection surface touched by a user may be translated into image coordinates rather than to symbols, in a similar manner to how touch screen coordinates are reported.

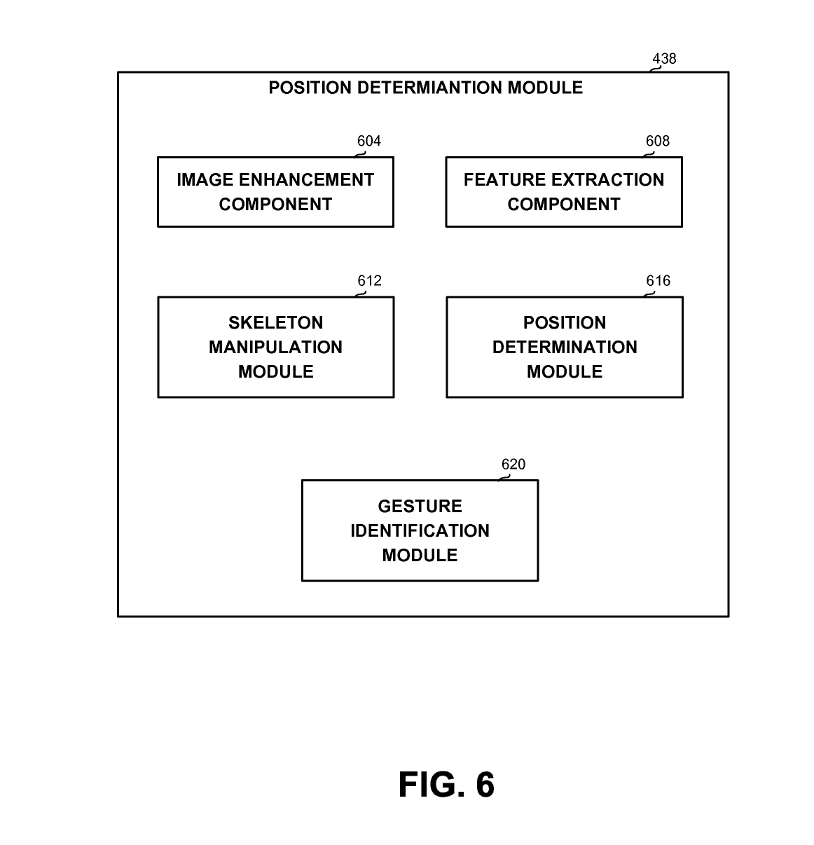

Step 308 may be activated and performed by input detection application 428 loaded to memory device 416 of computing platform 400. In some embodiments, input detection application 428 may comprise control and data flow management module 432, position retrieval module 438 of FIG. 4, and optionally user interface module 434 if user intervention is required, for example if the capturing device is not directed at the projected image, if light conditions are insufficient, or the like. Position retrieval module 438 may be used in a registration phase at which correspondence between a symbol or control command and a location on or including the projection surface is determined. Position retrieval module 438 may further be used during operation stage for determining the location of a user's hand. Position retrieval module 438 is further detailed in association with FIG. 6 below.

FIG. 3B is a flowchart of steps in a method for receiving input from a user and providing the input to a computing platform.

On step 322 a screen image, such as an image that may or may not be displayed on a display device associated with computing platform 400, is projected by a projection device 402 onto a projection surface, such as the projection surface for which registration was performed in accordance with the method of FIG. 3A. Communication between computing platform 400 and projection device 402 may be performed by computing platform 400 executing projection device driver 420.

On step 324 an image or reflection is captured of a body part such as a hand or hands or a one or more fingers in proximity to the projected image. The image is captured by capture device 404 as controlled by capture device driver 424. The image may be captured as part of a series of images taken at predetermined or dynamically determined rate. Capture device 404 may be a web camera, a video camera, a stills camera capable of capturing frequent images, or the like.

On step 328 a symbol or command is determined, which is associated with a 2D area or the 3D region of the projected image to which the body part as appearing in the captured image is closest. Step 328 is further detailed in association with FIG. 5B below. The symbol or command are determined based on the association performed on step 308 of FIG. 3A.

On step 332 the symbol or command is provided as input, for example to an application executed by the computing platform, with which the projected image is associated.

Steps 328 and 332 may be activated and performed by control and data flow management module 432 and position retrieval module 438 of FIG. 4.

It will be appreciated that registration may be performed once after a change to the location of the computing platform, the projection device or the capturing device, in which case the registration associates locations on the projection surface with coordinates. Alternatively, registration may be performed for each newly displayed image for associating locations on the projection surface with symbols or control commands associated with the image.

Referring now to FIG. 5A, showing a flowchart of steps in a method for image registration, i.e., determining association between 2D areas or 3D regions which include parts of a projection image, and characters or control commands to be input to a computing platform, and to FIG. 5B showing a flowchart of steps in a method for determining input to a computing platform from an acquired image, by an HMI system. The method of FIG. 5A provides an exemplary embodiment of step 308 of FIG. 3A, and FIG. 5B provides an exemplary embodiment of step 328 of FIG. 3B. Also referring to FIG. 6, showing an exemplary embodiment of position retrieval module 438 of FIG. 4.

On step 500, the reflection or image of the projection surface, as captured on step 304 undergoes image enhancement, which may include background removal, edge detection, or other processes which may be associated with image processing. This step may be performed by image enhancement module 604.

On step 504 one or more symbols or image parts are identified within the captured image. The symbols may include characters displayed as part of a projected image of a keyboard, buttons, scroll bars, other controls, or the like. Identification can be done by any one or a combination of relevant image processing techniques, including for example pattern recognition or others. Since the contents of the projected image, i.e., a general form of the characters and relative locations are known, the symbols can be more easily identified within the captured and enhanced image. The symbols or other features on the image may be extracted using feature extraction component 608 of FIG. 6.

On step 508, each displayed symbol or image area is associated with a relevant character or control command. This step can be performed as part of step 504, since the characters or controls may be used for identifying the symbols on the acquired image on step 504.

On step 512, each of the detected symbols or image parts is associated with 2D areas of the projection surface, or 3D regions including areas of the projection surf

Using the associations made on step 508 and 512, each 2D or 3D area on or which includes part of the projection surface may be associated with a character or a control command to be input into the computing platform. This association enables step 308 of FIG. 3A, which provides association between location on or in the vicinity of the projected image and characters or control commands available to a user.

It will be appreciated that the order of steps 508 and 512 can be reversed, and that steps 504, 508 and 512 can be implemented using a different distinction between the steps, performed in different order or otherwise changed.

Referring now to FIG. 5B, showing a flowchart of steps in a method for determining input to a computing platform from a reflection of a projected image, by an HMI system.

On step 520 the image of the body part in the vicinity of the projected image as captured on step 324 of FIG. 3 is enhanced, optionally in a similar manner to the enhancement performed on step 500, and also by image enhancement module 604.

On step 524 features are extracted from the enhanced image, and in particular a body part is identified within the image. Step 524 can be performed using any image processing method for feature extraction. The body part features or other characteristics on the image may be extracted using feature extraction component 608 of FIG. 6. In some embodiments, feature extraction component 608 can comprise two different modules, one for identifying features such as symbols as required on step 504, and another for extracting body part features as required by step 524.

On step 532 the position of the body part captured in the image may be determined, for example in the coordinate system relative to the projected image, as defined during the registration stage. The location may comprise one or more coordinates or coordinate range, including for example the point in the body part closest to the projected image. Position determination step 532 may be performed by position determination module 616 of FIG. 6.

On optional step 536, a gesture made by the body part may be identified. It will be appreciated that the method may require the capturing and analysis of multiple images, since a body part may appear within an area in more than one image, but it may not be desired to report the same symbol or command multiple times. Therefore it may be required to further analyze the gestures performed by the hand, in order to determine when the body part is closest to the projection surface, i.e., when the distance between the body part of and the surface starts to increase after decreasing, and only then report the symbol or control command. The gesture and the point in time at which the body part is closest to the projection surface may be identified by gesture identification module 620 of FIG. 6. In some embodiments the images may be captured in a predetermined rate, or in a rate which may be determined in accordance with each specific user, based for example on the user's movements.

In some embodiments, analyzing the motion of a part such as a finger tip may be helpful in predicting the destination area of the fingertip, e.g. the area of the projection surface the fingertip is getting closer and closer to. The area can be highlighted, for example by a frame of different color or a bolded frame, so as to help the user.

In some embodiments, feature extraction step 524, body part position determination step 532 and gesture identification step 536 may be performed using a skeleton model of the hand as detailed for example in U.S. Pat. No.: 8,114,172 and U.S. Pub. No.: 2011-0129124-A1, both of which are hereby incorporated in their entirety herein by reference. Using such model, it is possible for example to identify certain feature or features of the hand, such as one or more joints or length ratios between segments of the hand. Using such skeleton model may provide for retrieving more accurately or more efficiently the position of the body part or a particular part thereof, such as a fingertip of the user.

Skeleton manipulation steps 528 can be activated for retrieving information of the hand and performing the skeleton-related parts of steps 524, 528 and 532. Skeleton manipulation steps 528 may be performed by skeleton manipulation module 612 of FIG. 6.

The skeleton model can be general and be applied to all users of the system. In other alternatives, a number of skeleton models can be offered, for example in some categories such as “child”, “small hand”, “large hand” or the like, so that each user can select a model. In yet other alternatives, a specific skeleton model can be constructed for each user based on the specific size and structure of the user.

In further embodiments, the skeleton model can be adapted during usage of the system by a person, by analyzing the user's motions through the captured images.

However, using a skeleton model is just one alternative, and in other embodiments any other image processing techniques may be used.

On step 540 the location or the 2D area on the projection surface, or the 3D region comprising a part of the projection surface, which includes or is closest to the location of the body part retrieved on step 536 is determined. In some embodiments a maximal distance is defined, such that if the distance between the point of the body part that is closest to the projection surface and the projection surface exceeds the distance, no symbol or control command is determined, in order to avoid false reporting due to the user hovering in the vicinity of the projection surface.

On step 544 the symbol or control associated with the 2D area or the 3D region, as determined on step 512 is retrieved. The symbol or command may then be input to the computing platform or an application, as described in association with step 332 of FIG. 3.

The flowchart and block diagrams in the figures illustrate the architecture, functionality, and operation of possible implementations of systems, methods and computer program products according to various embodiments of the present disclosure. In this regard, each block in the flowchart and some of the blocks in the block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, any non-transitory computer-readable medium, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A computerized apparatus for receiving input from a user, comprising:
a computing platform for generating an image to be displayed to the user;
a projection device for generating a projected image on a projection surface;
a capturing device for obtaining a captured image of a user's body part and a part of the projected image; and
an input detection application for determining input from the captured image, in accordance with proximity between a part of the user's body and a part of the projected image, the input detection application comprising:
a control and data flow management module for activating a registration stage for determining association between a symbol or a control command and a two dimensional area of a projection surface or a three dimensional area including the projection surface, and an operation stage for determining input from a captured image of the user's body part; and
a position identification module for determining a location of the part of the user's body based on the association performed during the registration stage.

2. The apparatus of claim 1 wherein the position identification module comprises a skeleton manipulation module for determining the location of a body part.

3. The apparatus of claim 1 wherein the position identification module comprises:
at least one feature extraction component for extracting symbols from a captured image of the projection surface, and for extracting body part features from an image of a body part of the user; and
a position determination module for determining a location of the body part.

4. The apparatus of claim 1 wherein the position identification module comprises a gesture determination module for determining the location of the body part from a multiplicity of images.

5. The apparatus of claim 1 wherein the position identification module comprises an image enhancement component for enhancing captured images.

6. A computerized apparatus for receiving input from a user, comprising:
a computing platform for generating an image to be displayed to the user;
a projection device for generating a projected image on a projection surface;
a capturing device for obtaining a captured image of a user's body part and a part of the projected image; and
an input detection application for determining input from the captured image, in accordance with proximity between a part of the user's body and a part of the projected image, the input detection application comprising:
a control and data flow management module; and
a position identification module for determining a location of the part of the user's body using a skeleton model of the part of the user's body.

7. The apparatus of claim 6 wherein the control and data flow management module is operative in activating a registration stage for determining association between a symbol or a control command and a two dimensional area of a projection surface or a three dimensional area including the projection surface, and an operation stage for determining input from a captured image of the user's body part.

8. The apparatus of claim 6 wherein the control and data flow management module comprises an image enhancement component for enhancing captured images.

9. The apparatus of claim 6 wherein the position identification module comprises:
at least one feature extraction component for extracting symbols from a captured image of the projection surface, and for extracting body part features from an image of a body part of the user; and
a position determination module for determining a location of the body part.

10. The apparatus of claim 6 wherein the position identification module comprises a gesture determination module for determining the location of the body part from a multiplicity of images.

11. A method for providing input from a user, comprising:
a registration stage comprising:
projecting a first image onto a projection surface to obtain a first projected image;
capturing the first projected image; and
associating an area of projection surface with a symbol or a control command; and
an operation stage comprising:
projecting a second image onto a surface to obtain a second projected image;
capturing a body part of the user with at least a part of the second projected image;
utilizing a computing platform for determining a symbol or a control command associated with body part as captured; and
providing the symbol or control command to the computing platform or to a second computing platform or to an application executed by the computing platform or by the second computing platform.

12. The method of claim 11 wherein determining the symbol or a control command comprises manipulating a skeleton model of the body part.

13. The method of claim 11 wherein associating the area of projection surface with the symbol or a control command comprises:
enhancing the first projected image to obtain an enhanced image;
extracting a displayed symbol or a part from the enhanced image;
associating the displayed symbol or part with a symbol or control command; and
associating the displayed symbol or part with a two dimensional area of the projection surface or a three dimensional region comprising an area of the projection surface.

14. The method of claim 11 wherein determining a symbol or a control command associated with body part as captured comprises:
enhancing the second projected image;
extracting a feature associated with the body part from the second projected image;
determining a location of the body part which is in proximity to the projection surface; and
retrieving a symbol or a control command associated with the location.

15. The method of claim 11 further comprising identifying a gesture performed by the body part.

16. The method of claim 11 wherein determining a location of the body part comprises determining capturing a multiplicity of second images and determining the symbol in accordance with an image of the multiplicity of second images in which the body part is closest to the projection surface.

17. A method for providing input to a computing platform from a user, comprising:
projecting an image onto a projection surface to obtain a projected image;
capturing a body part of the user with at least a part of the projected image;
utilizing a computing platform for determining a symbol or a control command associated with body part as captured in accordance with association between a location of the body part and the symbol or a control command, using a skeleton model of the body part; and
providing the symbol or control command to the computing platform or to a second computing platform or to an application executed by the computing platform or by the second computing platform.

18. The method of claim 17 further comprising a registration stage, the registration stage comprising:
projecting a first image onto a projection surface to obtain a first projected image;
capturing the first projected image; and
associating an area of projection surface with a symbol or a control command.

19. The method of claim 17 wherein determining a symbol or a control command associated with body part as captured comprises:
enhancing the projected image;
extracting a feature associated with the body part from the projected image;
determining a location of the body part which is in proximity to the projection surface; and
retrieving a symbol or a control command associated with the location.

20. The method of claim 17 further comprising identifying a gesture performed by the body part.

21. A computer program product comprising:
a non-transitory computer readable medium;
a first program instruction for projecting a first image onto a projection surface to obtain a first projected image;
a second program instruction for capturing the first projected image;
a third program instruction for associating an area of projection surface with a symbol or a control command;
a fourth program instruction for projecting a second image onto a surface to obtain a second projected image;
a fifth program instruction for capturing a body part of a user with at least a part of the second projected image;
a sixth program instruction for determining a symbol or a control command associated with body part as captured; and
a seventh program instruction for providing the symbol or control command to a computing platform or an application executed by the computing platform,
wherein said first, second, third, fourth, fifth, sixth and seventh program instructions are stored on said non-transitory computer readable medium.

22. A computer program product comprising:
a non-transitory computer readable medium;
a first program instruction for projecting an image onto a surface to obtain a projected image;
a second program instruction for capturing a body part of a user with at least a part of the projected image;
a third program instruction for determining a symbol or a control command associated with body part as captured in accordance with association between a location of the body part and the symbol or a control command, using a skeleton model of the body part; and
a fourth program instruction providing the symbol or control command to a computing platform or an application executed by the computing platform,
wherein said first, second, third, and fourth program instructions are stored on said non-transitory computer readable medium.
